(19) United States
(12) Patent Application Publication
(10) Pub. No.: US 2014/0202083 A1
(43) Pub. Date: Jul. 24, 2014

(54) FRAMING FOR PANELS

(71) Applicant: Eric Joray, St- Aubin (CH)

(72) Inventor: Eric Joray, St- Aubin (CH)

(73) Assignee: Orchidees Constructions SA, St-Aubin-Sauges (CH)

(21) Appl. No.: 14/235,279

(22) PCT Filed: Feb. 1, 2012
(86) PCT No.: PCT/IB2012/050480

§ 371 Date: Jan. 27, 2014

(30) Foreign Application Priority Data
May 20, 2011 (EP) 11166993.3

(51) Int. Cl. E05D 15/06; E06B 3/46

(52) U.S. Cl. CPC E05D 15/0691; E06B 3/4609; E05D 15/0678
USPC 49/425

(57) ABSTRACT

Frameworks for walls sliding in an opening defining an outer surface, especially for windows and French windows, arranged to support one wall, the outer surface being aligned with the ceiling or floor of the building in which the framework is arranged, the framework including a stationary frame, an intermediate element attached to the wall, and movement means allowing the wall to move relative to the stationary frame, the framework comprising at least one through-groove through which the intermediate element passes, and a slider is connected to one of the ends of the intermediate element, and the movement means engages with the slider and/or with the stationary frame to move the wall along a predetermined path, the stationary frame being positioned entirely above or below the outer surface such that the stationary frame does not project any elements from the opening.

### FIELD OF INVENTION

The present invention relates to a framing for panels sliding in a recess, in particular for windows and French windows and arranged for supporting at least one panel.

The object of the present invention is to propose a framing in which the different component parts of the fixed frame are positioned wholly above or below the outer surface of said recess such that the fixed frame does not exhibit any element protruding outside the framing. In combination with the object described above, it is also an object of the present invention to propose a framing such that the panels are capable of being displaced along a given substantially rectilinear trajectory or one of variable orientation, in particular along a given winding and/or angular trajectory, in particular comprising at least one substantially right angle.

### BACKGROUND OF THE INVENTION

In conventional framings for panels sliding in a recess, the longitudinal profiled elements of the fixed frame are positioned, at least partially, so as to protrude from the recess in such a way as to support the panel. It is known to use various devices associated with said fixed frame to offer sliding support to the panel. European Patent Application EP 2 221 440 A1 details and claims such a framing and such a sliding support while European Patent Application EP 2 093 364 A1 details and claims another type of sliding support. The elements of the framing, in particular the fixed frame, positioned outside the recess form protrusions relative to the floor or the ceiling and have various drawbacks, both aesthetic and functional. First of all, such elements interrupt the planes formed by floor and ceiling. This type of framing therefore breaks up the continuity and unity of the floor and ceiling. This is detrimental to the aesthetic appearance of the building. Said elements protruding from the recess also have major disadvantage in terms of the risk of somebody tripping up and injuring themselves while moving between the spaces separated by the recess. In particular, such a person's foot could collide with the lower part of the framing. Furthermore, these protruding elements constitute obstacles which are difficult to negotiate for people in wheelchairs or using a walking frame. Furthermore, it can be very difficult to manoeuvre objects, whether wheeled or not, due to said protruding elements. Examples of such objects which may need to be manoeuvred are in particular furniture, especially chairs, chaises longues, armchairs and tables, as well as parasols, barbecues, pot plants or any ornamental item.

Moreover, conventional framings for panels are configured such that the panels slide along a rectilinear fixed frame. Such framings are not therefore suitable for displacing panels along a given trajectory of variable orientation, in particular along a given winding and/or angular trajectory, in particular comprising at least one substantially right angle. This is because conventional framings cannot prevent the sliding panels from jamming upstream of a winding and/or angular portion of the given trajectory. Hence, conventional framings do not allow the opening of spaces which are separated by a recess with a winding and/or angular geometry. Many modern constructions are, for example, provided with conservatories or other loggias with ground projections in the shape of a polygon, in particular a rectangle or a trapezium, or more complex geometric shapes. These structures generally comprise sliding panels. Nonetheless, by using conventional framings for panels, these structures can only be partially opened and in rectilinear sections, said framings not permitting the opening of spaces separated by a recess with a winding and/or angular geometry.

The present invention therefore aims to provide a solution to the above-mentioned problems.

### DISCLOSURE OF THE INVENTION

To this end, the invention proposes a framing for panels according to claim 1. Other possible configurations of the invention are defined in claims 2 to 20.

The invention configured in this way provides a framing in which the fixed frame is positioned wholly above or below the outer surface of the recess such that the fixed frame does not display any element protruding outside the recess. Since the planes formed by floors and the ceilings are not interrupted by the component parts of the fixed frame, there is nothing to detract from the attractiveness of the location. The framing according to the invention provides the floors and ceilings between the spaces separated by the recess with continuity and unity. Due to the absence of any element of the fixed frame protruding from the recess, movement between the spaces separated by the recess is not obstructed and there is no risk of tripping and injury. Access to the spaces separated by the recess for disabled persons or persons with reduced mobility, and manoeuvring of objects between said spaces is also made easier.

The invention configured in this way also provides a framing for panels such that displacement of panels along a given trajectory is not limited to a substantially rectilinear given trajectory. The framing according to the invention allows displacement along a given trajectory with variable orientation, in particular along a given winding and/or angular trajectory, in particular comprising at least one substantially right angle. In this way, spaces separated by a recess with a winding and/or angular geometry may be fully opened.

### BRIEF DESCRIPTION OF THE DRAWINGS

Other advantages and features of the present invention will be better understood from reading about specific embodiments of the invention described with reference to the drawings, in which:

FIG. 1 is a sectional view along a transverse plane of a framing according to the invention, in a first embodiment;

FIG. 2 is a sectional view along a longitudinal plane A-A of the lower part of the framing according to FIG. 1;

FIG. 3 is a sectional view along a vertical plane of the lower part of a framing according to the invention, in a second embodiment;

FIG. 4 is an exploded axonometric perspective view of the lower part of the framing of FIG. 3;

FIG. 5 is a vertical section of the lower part of a framing with two adjacent frames according to the invention, the two frames being in accordance with the second embodiment of the invention shown in FIGS. 3 and 4;

FIG. 6 is a sectional view along a vertical plane of the lower part of a framing according to a second variant of the second embodiment.

### DETAILED DESCRIPTION OF THE EMBODIMENTS OF THE INVENTION

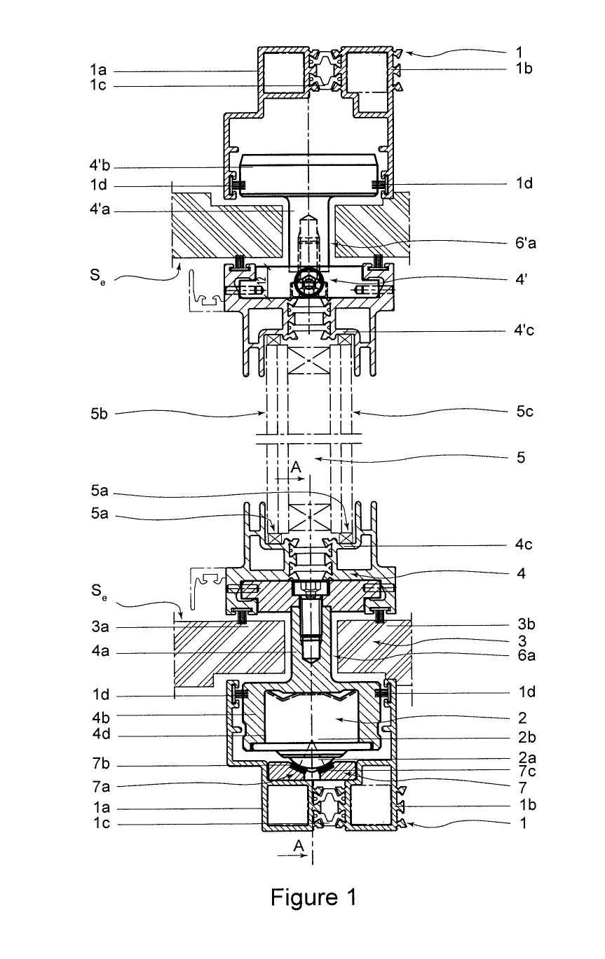

The invention is described with reference to FIGS. 1 to 6[I1], which illustrate, by way of example, different embodiments of the invention suitable for supporting double glazing. These examples of application do not in any way limit the present invention. Furthermore, the device of the invention may be applied to other types of panels.

FIG. 1 is a sectional view along a transverse plane of a framing according to the invention, in a first embodiment. The lower part of the framing will be described first. The framing, arranged to support a panel 5, here consisting of double glazing, comprises an intermediate element 4, a fixed frame 1 and displacement means 2 allowing displacement of the panel 5 along the fixed frame 1. The fixed frame 1 comprises two wings 1a and 1b assembled with the aid of fixing means 1c. The intermediate element 4 is intended to be fixed to the panel 5. In order to do this, the intermediate element 4 comprises a profile 4c, for example, in the shape of a U, capping the panel 5 on one of its longitudinal edges 5a, the intermediate element 4 and the panel 5 being firmly connected by adhesive bonding of at least one face 5b and 5c of the panel 5 to at least one wing of the U-shaped profile 4c. Other geometries for the profile 4c, such as an L-shaped profile or a planar longitudinal profile, may be used instead of a U-shaped profile by adapting the connecting means between the profile 4c and the panel 5. Other connecting means, such as nuts and bolts or welding, may be used instead of or together with said adhesive bonding. Furthermore, according to the sectional view in FIG. 1, the intermediate element 4 comprises a pin 4a and a pad 4b, the pin 4a being connected at one of its ends to the profile 4c and the pad 4b being connected to the other end of the pin 4a. The pin 4a and the pad 4b are preferably cylindrical in shape. The diameter of the pin 4a is less than 20 mm, preferably equal to 15 mm. The diameter of the pad 4b is dimensioned so as to be positionable between the wings 1a and 1b of the fixed frame 1. Indeed, the pad 4b is guided between the wings 1a and 1b of the fixed frame 1, these wings being equipped with brushes 1d. The diameter of the pad 4b is less than 80 mm, preferably equal to 70 mm. The framing recess 3, consisting in the case of the lower part of the framing of the floor of the building inside which said framing is arranged, defines an outer surface Sₑ and comprises a through groove 6a defining two lateral recess elements 3a and 3b. A through groove is intended to mean a groove opening on either side of the recess 3. The through groove 6a has a width of less than 25 mm, preferably equal to 20 mm, while its section is preferably rectangular. The pin 4a passes through the through groove 6a in such a way that the profile 4c is positioned wholly outside the recess 3, that is to say above the outer surface Sₑ of the lateral recess elements 3a and 3b, while the fixed frame 1 is positioned wholly below the outer surface Sₑ in such a way that the fixed frame 1 does not exhibit any element protruding outside the recess 3. The outer surface Sₑ may advantageously be aligned with the floor of the building inside which said framing is disposed. The pin 4a is preferably transversely centred in the through groove 6a and the diameter of the pin 4a is dimensioned such that the transverse distance between the pin 4a and the recess 3 is less than 5 mm, preferably equal to 2.5 mm. In this first embodiment of the invention, the pad 4b comprises displacement means 2, which cooperate with the fixed frame 1. In particular, the pad 4b is equipped with a spherical ball 2a mounted for rotation. Advantageously, the ball 2a mounted for rotation in the pad 4b is capable of pivoting in all directions. In one configuration of the invention, the ball 2a is mounted for rotation in a ball transfer unit 2b, the ball transfer unit 2b being fitted in a receptacle 4d in the pad 4b. Such a ball transfer unit 2b is known per se from the prior art. The ball transfer unit 2b is preferably of the Always Euro brand, reference number 522, type 15. The ball 2a is positioned in the ball transfer unit 2b such that part of the ball 2a protrudes outside the ball transfer unit 2b. The protruding part of the ball 2a is intended to cooperate with guide means 7 of the fixed frame 1, the fixed frame 1 comprising guide means 7 intended to cooperate with the ball 2a so as to displace the panel 5 along a given trajectory. In a preferred configuration of the invention, the guide groove 7a, intended to receive and guide the ball 2a, advantageously has a V-shaped section, the ball 2a cooperating with the sidewalls of the guide groove 7a. In a second configuration of the invention, the guide means comprise a guide groove of concave section intended to receive and guide the ball mounted for rotation in the pad, the concavity of the guide groove being complementary to the convexity of the ball. The guide means 7 are advantageously provided with at least one support strip cooperating with the displacement means 2. If the guide groove section 7a is in a V shape, two support strips 7b and 7c are arranged on the sidewalls of the guide grooves 7a. The support strip(s) is/are advantageously of stainless steel or brass while the ball 2a is of stainless steel. The guide groove 7a may define a substantially rectilinear trajectory or a trajectory of variable, in particular winding and/or angular orientation, in particular comprising at least one substantially right angle. If the guide groove 7a defines a trajectory of variable orientation, the through groove 6a and the fixed frame 1 comprising the guide groove 7a each advantageously define the same variable orientation as the guide groove 7a. Moreover, if the guide groove 7a defines an angular trajectory, the angle could be sharp or in the form of a rounded chamfer, the rounded chamfer offering the advantage of more fluid displacement of the panel along the guide groove 7a.

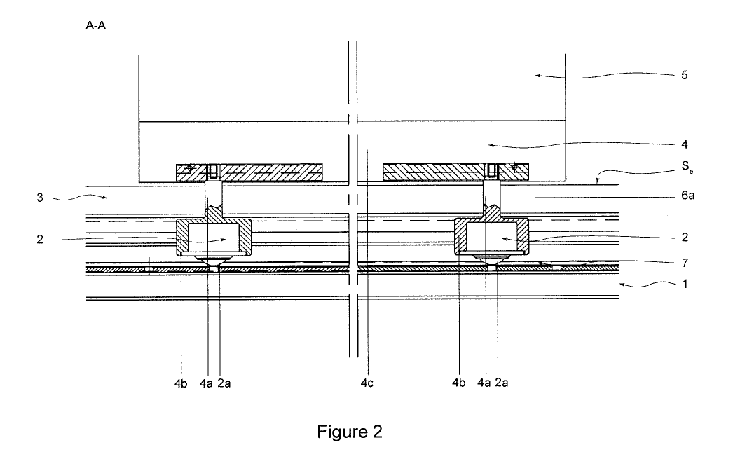

FIG. 2 is a sectional view along a longitudinal plane A-A of the lower part of the framing according to FIG. 1. This view of the framing shows the same elements as in FIG. 1 so meaning that it is not necessary to list them again. In this first embodiment, the framing according to the invention, and more specifically the intermediate element 4, has two longitudinally spaced pins 4a. A pad 4b is connected to one end of each pin 4a. The two pins 4a are arranged as extensions of the longitudinal ends of the panel 5, so as to stabilise the panel with regard to any pivoting thereof around a transverse pin. The pads 4b are each provided with a spherical ball 2a mounted for rotation and intended to cooperate with the guide means 7, in particular with the guide groove 7a. The longitudinally spaced pins 4a thus pass through one and the same through groove 6a and the balls 2a with which each pad 4b is equipped cooperate with the same guide groove 7a such that, during displacement of the panel 5 along the guide groove 7a, the pins 4a, and, consequently, the balls 2a, pass successively over the same portion of the guide groove 7a.

Following on from the description of the lower part of the framing according to the invention made with reference to FIGS. 1 and 2, the upper part of the framing will now be described with reference to FIG. 1. According to the description of the lower part of the framing according to the invention, the panel 5 rests via the intermediate element 4 and displacement means 2 on the guide means 7 of the fixed frame 1. Consequently, the upper part of the framing has only to perform functions relating to the support and guidance of the panel 5 in the fixed frame 1. Therefore, the upper part of the framing comprises an intermediate element 4′, intended to be fixed to the panel 5 and comprising a profile 4′c substantially similar to the profile 4c of the intermediate element 4, a pin 4′a substantially similar to the pin 4a and a pad 4′b, the pin 4′a being connected at one of its ends to the profile 4′c and the pad 4′b being connected to the other end of the pin 4′a. The recess in the framing, consisting in the case of the upper part of the framing of the ceiling of the building inside which the framing is arranged, defines the outer surface Sₑ and comprises a through groove 6′a advantageously vertically above the through groove 6a. The through groove 6′a preferably defines a trajectory which is substantially rectilinear or has a variable orientation identical to that of the guide groove 7a and, all the more so, of the through groove 6a. The pin 4′a passes through the through groove 6′a such that the profile 4′c is positioned wholly outside the recess, that is to say below the outer surface Sₑ, while the fixed frame 1 is positioned wholly above the outer surface Sₑ such that the fixed frame does not reveal any element protruding outside the recess. The outer surface Sₑ may advantageously be aligned with the ceiling of the building inside which the framing is arranged. The pad 4′b is preferably guided between the wings 1a and 1b of the fixed frame 1, which are equipped with brushes 1d. The pad 4′b is preferably cylindrical in shape and its diameter is identical to that of the pad 4b. In another configuration of the invention, the pad may comprise displacement means cooperating with the fixed frame. In particular, the pad of the upper part of the framing may be equipped with a roller mounted for rotation about an pin centred relative to the intermediate element, said roller cooperating with the fixed frame to support and guide the panel along the fixed frame. As in the description of the lower part of the framing made with reference to FIG. 2, the upper part of the framing according to the invention comprises two longitudinally spaced pins. A pad is connected to one end of each pin. The longitudinally spaced pins of the upper part of the framing therefore pass through one and the same through groove such that, during displacement of the panel along the guide groove, the pins pass successively over the same portion of the through groove.

Advantageously, a plurality of panels equipped with intermediate elements and displacement means are arranged along the same guide groove. These panels are capable of being displaced along the same guide groove.

By virtue of the framing configured in this way, in particular with reference to the descriptions above of the lower and upper parts of the framing, the panel 5 is capable of being displaced along the guide groove 7a along a substantially rectilinear trajectory or a trajectory of variable orientation, in particular along a winding and/or angular trajectory, in particular comprising at least one substantially right angle. Displacement of the panel 5 is not therefore limited to given rectilinear or virtually rectilinear trajectories. Furthermore, by virtue of the framing being configured in this way, said framing does not, when open, reveal any element protruding outside the recess 3, the various component elements of the fixed frame 1 being positioned wholly below the outer surface Sₑ in the case of the lower part of the framing and above the outer surface Sₑ in the case of the upper part of the framing. From both an aesthetic and functional point of view, the above-stated drawbacks of conventional framings are avoided.

Below, the applicant proposes a description of a second embodiment of the invention. It is the configuration of the intermediate element and displacement means which primarily differs relative to the first embodiment described above with reference to FIGS. 1 and 2. Instead of the intermediate element comprising a pad comprising displacement means cooperating with the fixed frame, in the second embodiment of the invention the displacement means are associated with the fixed frame and cooperate with the pad of the intermediate element. Moreover, the pins of the intermediate element are replaced by at least one main longitudinal wing. The second embodiment of the invention is configured such that the panel is capable of being displaced along a substantially rectilinear trajectory. This second embodiment corresponds in particular to that described with reference to FIGS. 1 to 4 in European Patent Application EP11166993.3 claimed as priority.

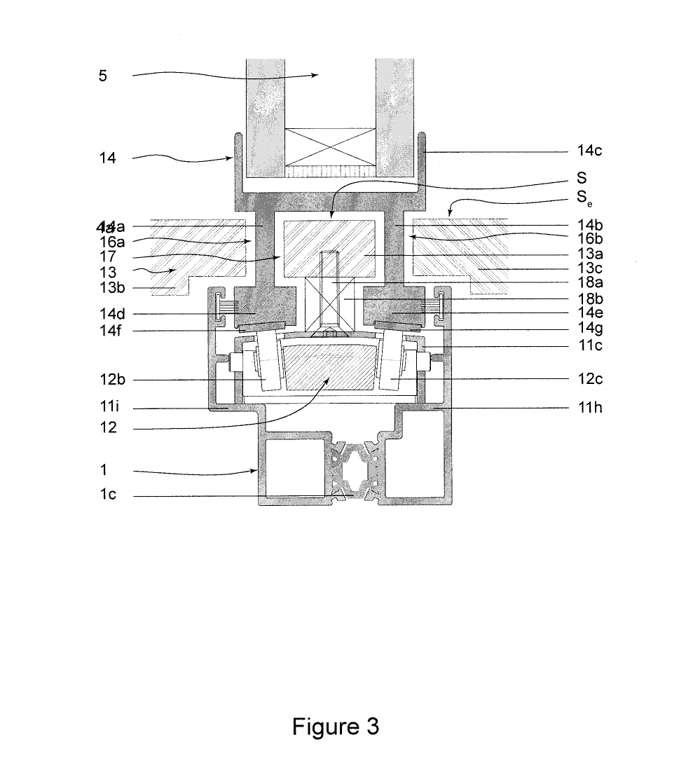

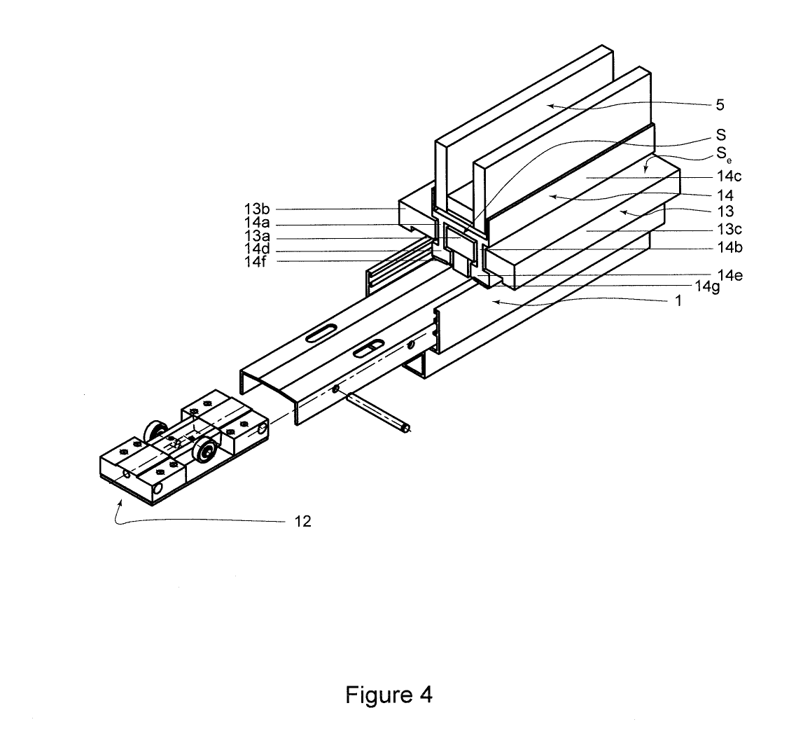

FIG. 3 is a sectional view along a vertical plane of the lower part of a framing according to the invention, in a first variant of the second embodiment. FIG. 4 is an exploded axonometric perspective view of the lower part of the framing of this same variant. The framing comprises an intermediate element 14, a fixed frame 1 and displacement means 12 associated with the fixed frame 1 and allowing displacement of the panel 5 along the fixed frame 1. The intermediate element 14 is designed to be fixed to the panel 5 by means of a profile 14c capping the panel 5 on one of its longitudinal edges in a manner similar to the first embodiment. The intermediate element 14 comprises two main longitudinal wings 14a and 14b connected to at one of their ends to the profile 14c and two pads 14d and 14e connected to the other end of the main longitudinal wings 14a and 14b. The pads 14d and 14e are advantageously longitudinal pads which extend along the main longitudinal wings 14a and 14b. The recess 13 comprises two through grooves 16a and 16b defining two lateral recess elements 13b and 13c and at least one intermediate recess element 13a disposed between the through grooves 16a and 16b. The main longitudinal wings 14a and 14b pass through the through grooves 16a and 16b such that the profile 14c is positioned wholly outside the recess, that is to say above the outer surface Sₑ of the recess 13 in the case of the lower part of the framing, while the fixed frame 1 is positioned wholly below the outer surface Sₑ in such a way that the fixed frame 1 does not exhibit any element protruding outside the recess 13. The outer surface Sₑ may advantageously be aligned with the floor of the building inside which said framing is disposed. Similarly, in the case of the upper part of the framing, the surface Sₑ will advantageously be aligned with the ceiling of the building inside which the framing is arranged, the configuration of the framing then being symmetrical relative to a horizontal plane of the configuration shown in FIG. 3. Furthermore, the longitudinal pads 14d and 14e are equipped with support strips 14f and 14g arranged longitudinally. The support strips 14f and 14g, preferably of stainless steel, cooperate with the displacement means 12 which comprise bearing-type sliding support units each having two ball bearings 12b and 12c rolling on the support strips 14f and 14g. European Patent Application EP 2 093 364 A1, filed by the applicant, details and claims such displacement means 12. Consequently, the intermediate element 14, by cooperating with the displacement means 12 associated with the fixed frame 1, allows displacement of the panel 5 relative to the fixed frame 1. The ball bearings 12b and 12c, preferably of the same size, are mounted on fixed pins and inclined in opposing directions at a slight angle relative to horizontal so as to ensure self-centring of the panel during sliding. The main longitudinal wings 14a and 14b bound a longitudinal channel 17 in the intermediate element 14 in which the intermediate recess element 13a is engaged. The intermediate recess element 13a may be held in the longitudinal channel 17 by various connecting means joined to the fixed frame 1. In FIG. 3, the fixed frame 1 comprises an inverted U-shaped covering profiled element 11c placed on two seats 11h and 11i of the longitudinal profiled elements forming the fixed frame 1. The seats are preferably coplanar. Using connecting means comprising at least one screw 18a and optionally a strut 18b, the intermediate recess element 13a is fixed to the covering profiled element 11c and held in the longitudinal channel. The intermediate recess element 13a is preferably dimensioned and positioned such that its outer surface S is on a level with the outer surface Sₑ of the lateral recess elements 13b and 13c.

Compared with the first embodiment described with reference to FIGS. 1 and 2, use of the invention according to the first variant of the second embodiment described above and comprising two main longitudinal wings is particularly advantageous for applications where the panel is relatively heavy. This is because the forces and stresses associated with the weight of the panel are absorbed and distributed by two main longitudinal wings instead of the two pins in the first embodiment described with reference to FIGS. 1 and 2.

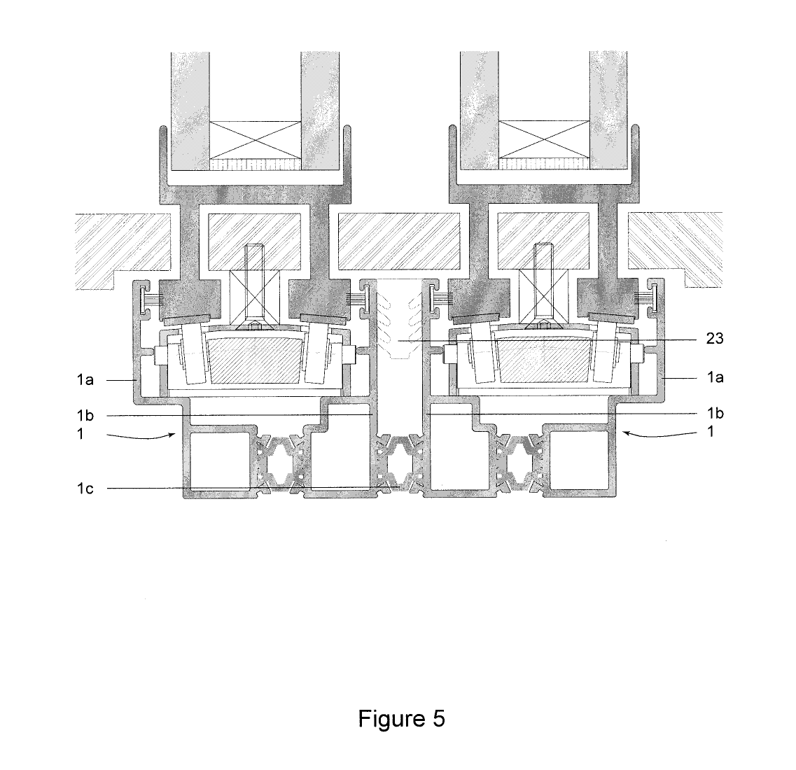

FIG. 5 shows a vertical section through the lower part of a framing consisting of two adjacent frames. The two fixed frames 1 are the same as those shown in FIGS. 3 and 4 apart from the fact that the longitudinal profiled elements 1a and 1b of each respective frame are positioned such that two longitudinal profiled elements 1b adjoin one another and consequently constitute the inner longitudinal profiled elements of the framing, the longitudinal profiled elements 1a constituting the outer longitudinal profiled elements of the framing. The two fixed frames 1 are held firmly together by fixing means 1c. In order to optimise thermal insulation, a thermal seal 23 is positioned between the longitudinal profiled elements 1b of the adjacent fixed frames 1.

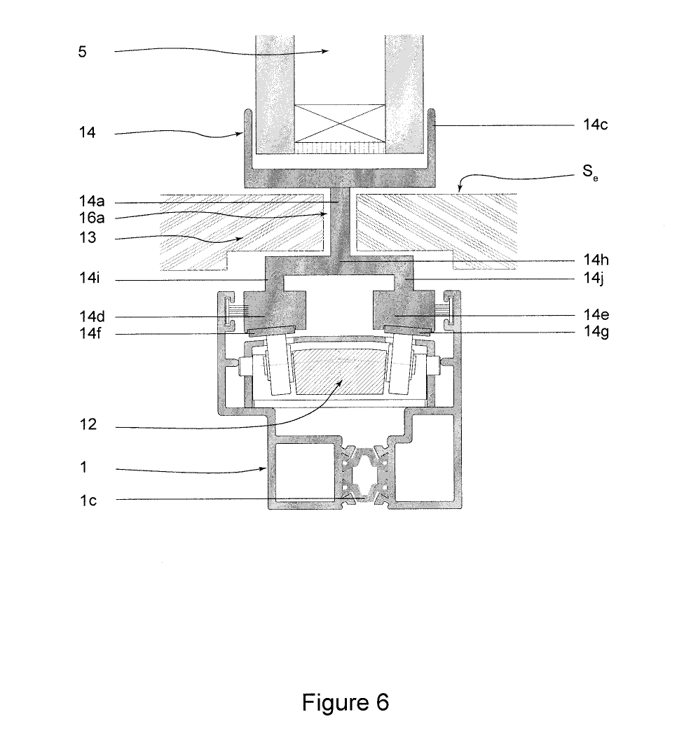

FIG. 6 is a sectional view along a vertical plane of the lower part of a framing according to a second variant of the second embodiment. The intermediate element 14 comprises a profile 14c intended to be fixed to the panel 5 and a main longitudinal wing 14a connected at one of its ends to the profile 14c and at the other end to a transverse wing 14h to which two longitudinal pads 14d and 14e are connected by means of two secondary longitudinal wings 14i and 14j. The two longitudinal pads 14d and 14e are respectively equipped with support strips 14f and 14g. In this device, the recess 13 comprises a through groove 16a. The main longitudinal wing 14a passes through the through groove 16a such that the profile 14c is positioned wholly outside the recess 13, that is to say above the outer surface Sₑ of the recess 13 in the case of the lower part of the framing. The fixed frame 1 is in turn positioned wholly below the outer surface Sₑ such that the fixed frame 1 does not exhibit any element protruding outside the recess 13. The outer surface Sₑ may advantageously be aligned with the floor of the building inside which said framing is disposed. Similarly, in the case of the upper part of the framing, the outer surface Sₑ will advantageously be aligned with the ceiling of the building inside which the framing is arranged, the configuration of the framing then being symmetrical relative to a horizontal plane of the configuration shown in FIG. 6. By means of longitudinal pads 14d and 14e and longitudinally arranged support strips 14f and 14g, the intermediate element 14 cooperates with the displacement means 12 associated with the fixed frame 1. This cooperation allows displacement of the panel 5 relative to the fixed frame 1.

The applicant proposes below the description of a third variant of the second embodiment of the invention. Compared with the second variant of the second embodiment described above and shown in FIG. 6, it is mainly the intermediate element and the displacement means which differ. The intermediate element, comprising a profile intended to be fixed to the panel and a main longitudinal wing connected at one of its ends to said profile, is provided with a single pad connected to the other end of the main longitudinal wing. The pad is preferably a longitudinal pad extending along the longitudinal wing. The main longitudinal wing passes through a through groove such that said profile is positioned wholly outside the recess, that is to say above the outer surface of the recess in the case of the lower part of the framing. The fixed frame is in turn positioned wholly below the outer surface such that the fixed frame does not exhibit any element protruding outside the recess. This outer surface may advantageously be aligned with the floor of the building inside which said framing is disposed. Similarly, in the case of the upper part of the framing, the outer surface will advantageously be aligned with the ceiling of the building inside which the framing is arranged, the configuration of the framing then being symmetrical relative to a horizontal plane of the configuration of the lower part of the framing. By means of the pad provided with a longitudinally arranged support strip, the intermediate element cooperates with displacement means associated with the fixed frame. These displacement means are described in European Patent Application EP 2 221 440 A1. They comprise bearing-type sliding support units. These are composed of a rail in the shape of an inverted U straddling two seats of the longitudinal profiled elements forming the fixed frame. Furthermore, the bearing-type sliding support units comprise a shaft passing transversely through the inverted U-shaped rail and carrying a ball bearing. By means of the support strip and the pad, the intermediate element rests on the ball bearing. The bearing-type sliding support units are placed at intervals along the fixed frame. Cooperation of the intermediate element with the displacement means allows displacement of the panel along the fixed frame following a substantially rectilinear trajectory.

1.-20. (canceled)

21. A semi-hidden framing assembly for panels for windows, comprising grooves within ceilings and floors along which the framing assembly slides at least one panel,
said framing assembly
having a fixed frame with guide means
and having an intermediate element adapted to be fixed to the panel,
said intermediate element comprising at least one pin and at least one pad connected to one end of said pin and
said pad comprising displacement means cooperating with said guide means so as to displace the panel along a given trajectory of the fixed frame,
wherein said displacement means comprise at least one spherical ball mounted for rotation on the end of said pad and capable of pivoting in all directions,
wherein said guide means comprise at least one guide groove intended to receive and guide said ball during displacement thereof,
wherein said grooves being through grooves through a floor and a ceiling along said fixed frame and through which said pin passes, said grooves being further defined by an upper surface that is aligned with a floor and with a lower surface that is aligned with a ceiling
and wherein the said fixed frame is positioned entirely above a ceiling and below a floor so that the fixed frame is not visible through the grooves when a panel of windows slides along the length of the fixed frame.

22. A semi-hidden framing assembly according to claim 21, wherein said trajectory of the fixed frame has a variable orientation.

23. A semi-hidden framing assembly according to claim 22, wherein said trajectory of the fixed frame is winding.

24. A semi-hidden framing assembly according to claim 21, wherein said trajectory of the fixed frame is substantially rectilinear.

25. A semi-hidden framing assembly according to claim 21, wherein said guide groove has a V-shaped section.

26. A semi-hidden framing assembly according to claim 21, wherein said guide groove has a concave section, the concavity of the groove being complementary to the convexity of the ball.

27. A semi-hidden framing assembly according to claim 21, wherein said intermediate element comprises at least two longitudinally spaced pins and wherein at least one pad is connected to one end of each pin.

28. A semi-hidden framing assembly according to claim 22, wherein said trajectory of the fixed frame is angular.

29. A semi-hidden framing assembly according to claim 21, wherein the guide means are provided with at least one support strip cooperating with the displacement means.

30. A semi-hidden framing assembly according to claim 25, wherein the guide means are provided with two support strips arranged on the sidewalls of the guide grooves and cooperating with the displacement means.
